(19) United States
(12) Patent Application Publication
(10) Pub. No.: US 2026/0343609 A1
(43) Pub. Date: Oct. 29, 2026

(54) INCLUDING TRAFFIC PROFILE IN MULTI-ACCESS POINT (AP) COORDINATION (MAPC) NEGOTIATION

(71) Applicant: Cisco Technology, Inc., San Jose, CA (US)

(72) Inventors: Brian D. Hart, Sunnyvale, CA (US); Binita Gupta, San Diego, CA (US); Malcolm Muir Smith, Richardson, TX (US)

(21) Appl. No.: 19/656,324

(22) Filed: Apr. 23, 2026

Related U.S. Application Data
(60) Provisional application No. 63/793,388, filed on Apr. 23, 2025.

(51) Int. Cl. H04W 74/0816; H04W 74/06; H04W 74/08

(52) U.S. Cl. CPC H04W 74/0816; H04W 74/06; H04W 74/0875

(57) ABSTRACT

Including traffic profile in Multi-Access Point (AP) Coordination (MAPC) negotiation may be provided. A traffic schedule is determined. The traffic profile may include a stream identifier and traffic characteristics for a flow associated with the stream identifier for each of one or more flows for associated stations. The traffic profile is sent to a plurality of co-channel Access Points (APs). A neighbor traffic profile may be received from each of one or more co-channel APs of the plurality of co-channel APs. A polling list may be created. The polling list may include the one or more co-channel APs and the neighbor traffic profile for each of the one or more co-channel APs may be created. Upon receiving a Transmit Opportunity (TXOP), it may be determined whether to poll at least one co-channel AP from the polling list for sharing the TXOP with.

### RELATED APPLICATION

Under provisions of 35 U.S.C. § 119(e), Applicant claims the benefit of U.S. Provisional Application No. 63/793,388, filed Apr. 23, 2025, which is incorporated herein by reference.

### TECHNICAL FIELD

The present disclosure relates generally to including traffic profile in a Multi-Access Point (AP) Coordination (MAPC) negotiation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for including a traffic profile in Multi-Access Point (AP) Coordination (MAPC) negotiation;

FIG. 2 is a flow chart of a method for providing a traffic schedule in MAPC negotiation; and

FIG. 3 is a block diagram of a computing device.

### DETAILED DESCRIPTION

### Overview

Including traffic profile in Multi-Access Point (AP) Coordination (MAPC) negotiation may be provided. A traffic schedule is determined. The traffic profile may include a stream identifier and traffic characteristics for a flow associated with the stream identifier for each of one or more flows for associated stations. The traffic profile is sent to a plurality of co-channel Access Points (APs). A neighbor traffic profile may be received from each of one or more co-channel APs of the plurality of co-channel APs. The neighbor traffic profile includes the stream identifier and the traffic characteristics for the flow identifier for each of one or more neighbor flows. A polling list including the one or more co-channel APs and the neighbor traffic profile for each of the one or more co-channel APs may be created. Upon receiving a Transmit Opportunity (TXOP), it may be determined whether to poll at least one co-channel AP from the polling list for sharing the TXOP with.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In the Institute of Electrical and Electronics Engineers (IEEE) 802.11bn (that ism Wi-Fi 8) amendment, Multi-Access Point (AP) Coordination (MAPC) may be considered as one of the main features. MAPC may allow higher network densification and higher network performance while avoiding or minimizing issues such as co-channel interference. There may be several MAPC modes of operation. MAPC modes may include, for example, Coordinated Spatial-Reuse (C-SR), Coordinated Time-Division-Multiple-Access (Co-TDMA), Coordinated Restricted Target Wake Time (Co-RTWT) and Coordinated Beamforming (Co-BF), etc. Other MAPC schemes may be considered for Wi-Fi8 or future generations of Wi-Fi may include Coordinated Frequency-Division-Multiple-Access (Co-FDMA), and Coordinated Orthogonal-Frequency-Division-Multiple-Access (Co-OFDMA), etc. In all these MAPC solutions, the APs may exchange signaling with each other to execute MAPC operation. For example, in Co-RTWT, Restricted-Target Wake Time (R-TWT) schedules are exchanged between APs, so APs can respect Service Period (SP) start time for R-TWT schedules from other APs.

Reliability and latency for the Wireless Fidelity (WiFi) may be improved via MAPC, including Co-TDMA. For example, at the beginning of each Co-TDMA exchange, a Transmit Opportunity (TXOP) holding AP may poll other nearby co-channel APs to determine if they have buffered Quality-of-Service (QOS) traffic. The polling may be performed via, for example, Initial Control Frame (ICF) or Initial Control Response (ICR) frames. The TXOP holding AP then may allocate a portion of the TXOP to one or more of these nearby APs if it has a higher priority traffic than the buffered Uplink/Downlink (UL/DL) traffic at the TXOP holding AP.

This polling may have overheads, and the TXOP holding AP may have many co-channel APs, especially in high density enterprise networks and/or when the Basic Service Set (BSS) bandwidth is wide. Therefore, it may be desirable to limit the polling to nearby APs that are more likely to have buffered traffic. Accordingly, embodiments of the disclosure may send Periodic Traffic Schedule Information (PTSI) which is an abstraction intended to cover messages or message portions that characterize parameters of periodic traffic such as Traffic Indication, Stream Classification Service (SCS), QC information, Coordinated Restricted Target Wake Time (Co-RTWT) schedules, TSPEC, etc. that it may have exchanged and negotiated with other APs towards determining which APs to poll during its Co-TDMA operation. To ensure Co-TDMA works efficiently, the disclosure may provide processes for an AP to notify nearby or co-channel APs of its periodic traffic within the evolving IEEE 802.11bn MAPC negotiation framework, including in an element or sub-element in a MAPC element.

The MAPC techniques may be described herein as initiated, established, and performed between APs and stations, but the MAPC techniques may be initiated and/or established by a primary AP, a controller, and/or another network device in additional embodiments. For example, controllers, central systems, and/or the like for the APs of different entities may communicate to establish the parameters of the MAPC techniques for the APs. The controllers, central systems, and/or other devices associated with the APs may establish the parameters or otherwise initiate the MAPC techniques when the APs of different entities cannot directly communicate. The MAPC techniques may use messages from non-AP stations as inputs.

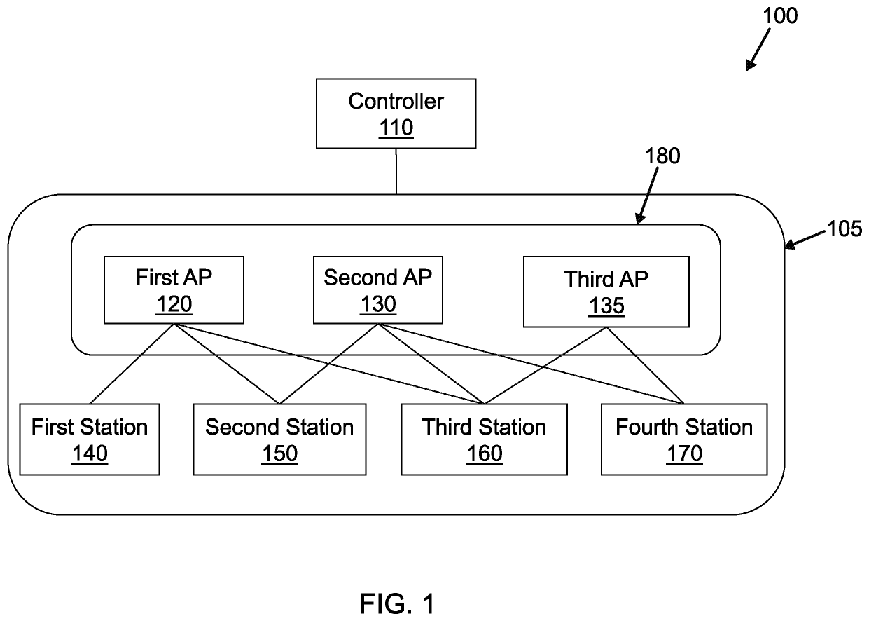

FIG. 1 is a block diagram of an operating environment 100 for including a traffic profile in a MAPC negotiation. Operating environment 100 may include a network 105 and a controller 110. Network 105 may include a plurality of network devices, for example, a plurality of APs (that is, a first AP 120, a second AP 130, and a third AP 135) and a plurality of stations (that is, a first station 140, a second station 150, a third station 160, and a fourth station 170). The plurality of APs (for example, first AP 120, second AP 130, and third AP 135) may form a MAPC group 180 to provide coordinated interference mitigation techniques for lowering latency, avoiding collisions, and/or otherwise improving network performance and determinism. Network 105 may comprise, but is not limited to, a Wireless Local Area Network (WLAN). Network 105 may also be referred to as a coverage environment.

Controller 110 may be a WLAN controller (WLC) and may provision and control network 105. Controller 110 may be implemented by a Digital Network Architecture Center (DNAC) controller (i.e., a Software-Defined Network (SDN) controller), an AP, another on premises network entity, or an off-premises network entity such as the cloud. Controller 110, first AP 120, and second AP 130 may provide a WLAN. Through this WLAN, first station 140, second station 150, third station 160, and fourth station 170 may be provided with access to the Internet or other cloud-based networking environments.

Each first AP 120, second AP 130, and third AP 135 may be compatible with specification standards such as, but not limited to, the Institute of Electrical and Electronics Engineers (IEEE) 802.11 specification standard for example. First AP 120 and second AP 130 may communicate with each other to conduct operations in concert. In addition, first AP 120, second AP 130, third AP 135 may be devices that can send and receive signals to provide a connection to network 105.

First station 140, second station 150, third station 160, and fourth station 170 may communicate with first AP 120, second AP 130, and third AP 135. First station 140, second station 150, third station 160, and fourth station 170 may be, for example, a smart phone, a personal computer, a tablet device, a mobile device, a telephone, a remote control device, a set-top box, a digital video recorder, an Internet of Things (IoT) device, a cellular base station, a telephone, a remote control device, a set-top box, a digital video recorder, a cable modem, a network computer, a mainframe, a router, or other similar microcomputer-based device capable of accessing and using a Wi-Fi network.

The plurality of APs and the plurality of stations may use Multi-Link Operation (MLO) where they are able to transmit and receive across different bands and channels by establishing two or more links to two or more AP radios. These bands may comprise, but are not limited to the 2.4 GHz band, the 5 GHz band, the 6 GHz band, and the 60 GHz band.

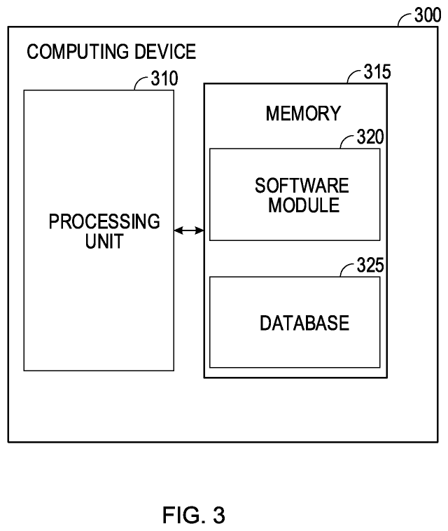

The elements described above of operating environment 100 (e.g., controller 110, first AP 120, second AP 130, third AP 135, first station 140, second station 150, third station 160, and fourth station 170) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300

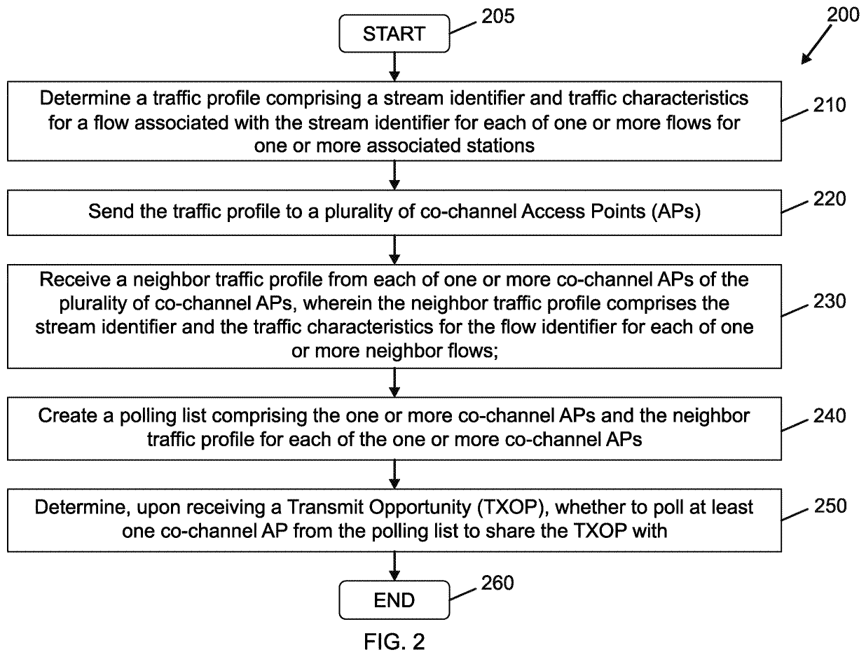

FIG. 2 is a flow chart setting forth the general stages involved in a method 200 consistent with embodiments of the disclosure for providing traffic profile in MAPC negotiation. Method 200 may be implemented by any of controller 110, first AP 120, second AP 130, and third AP 135 as described in more detail above with respect to FIG. 1. Ways to implement the stages of method 200 will be described in greater detail below.

Method 200 may begin at starting block 205 and proceed to stage 210 where first AP 120 may determine a traffic profile including a stream identifier and traffic characteristics for a flow (including a set of alike sub-flows that can be aggregated and thereafter treated as a single flow) associated with the stream identifier for each of one or more flows for associated stations. The plurality of stations may report their traffic flows (e.g., the communications of data packets between a source and destination with respective QoS requirement) to an associated AP. For example, each of first station 140, second station 150, and third station 160 may report their traffic flows to first AP 120. In certain implementations, the plurality of stations may report the traffic flows via one or more SCS frames each comprising one or more SCS Descriptor and each SCS Descriptor containing a QoS Characteristics (QC) element (e.g., a SCS(QC) frame). The QC element may include information for determining the requirements and parameters associated with the respective QoS traffic flow, such as traffic type, traffic class, priority level, the minimum data rate, the maximum data rate, bandwidth requirement, jitter requirements, maximum acceptable latency, acceptable packet loss percentage, maximum burst size, (such as service interval and optionally flow start time) and admission control parameters, and/or the like. In other embodiments, an AP or delegated network element might use techniques to infer or estimate many of these parameters, such as the schedule parameters and maximum acceptable latency.

First AP 120, for example, may receive periodic QoS traffic flows from each of first station 140, second station 150, and third station 160, and corresponding reports, determine which are alike flows if any and thereby aggregate alike flows where possible to yield a set with the same number of or fewer aggregated flows, and determine the traffic profile comprising a list of stream identifiers and traffic characteristics for a flow associated with the stream identifier for the one or more aggregated flows for associated first station 140, second station 150, and third station 160. First APs 120 can determine traffic profile for implementing the MAPC techniques.

After determining the traffic profile at stage 210, method 200 may proceed to stage 220 where first AP 120 may send the traffic profile to a plurality of co-channel APs. First AP 120 may send the traffic profile to, for example, second AP 130 through MAPC sub-elements. In some examples, the traffic profile may be shared for selection by second AP 130 (also referred to as a TXOP holding AP of nearby co-channel APs) so TXOP sharing can be informed and optimized. In one example, the traffic profile may be sent through Periodic Traffic Schedule Information (PTSI). The PTSI may include a plurality of fields. Each of the plurality of fields of the PTSI may include one or more of traffic characteristics of aggregated flow. For example, the PTSI may include a flow identifier field comprising a flow identifier such has a SCS Identifier (SCSID), an identifier that may an otherwise unused value of the SCSID, or some other identifier for the aggregated flow. In one implementation, the flow identifier may be of a predetermined length, for example, 4, 8, 12, 16, 24, or 32 bits.

The PTSI may further include an operator field including an operator, such as, an add, change, or delete. In implementations where the operator field includes delete, then some of the below listed fields of the PTSI may be reserved or omitted. The PTSI may further include a Service Start Time (SST) field. The SST field may be referenced to a recipient's Timing Synchronization Function (TSF) or a transmitter's TSF.

The PTSI may further include an SST range field that may include a SST range that may indicate a window of desirable start times following the SST. The SST range may be referenced to the recipient's TSF or the transmitter's TSF. In some implementations, per a preamble, there may not be an SST range, or may not be both the SST and the SST range.

The PTSI may further include a service interval field that may include a service interval. The service interval may also be referenced to the recipient's TSF or the transmitter's TSF. In some implementation, a time base for the service interval may be left unspecified. The service interval may be encoded as a linear value or as a mantissa and exponent.

The PTSI may further include a nominal duration field that may include a nominal duration required to service the flow at each service period. The PTSI may further include a priority field that may include a measure of priority, for example, an Access Category (AC), a Traffic Identifier (TID), a Differentiated Services Code Point (DSCP), or some other commonly agreed priority scale for the flow.

The PTSI may further include a nominal duration filed that may include a nominal duration indicating whether the traffic flow is entirely, predominantly, or occasionally being delivered on this link. For example, with MLO, there may be an active link on which a client delivers most of its traffic, and that active link may be on the channel under consideration or a different channel. If there is no MLO, then all traffic may be delivered on the channel under consideration.

The formatting and encoding of these fields may follow a body of the QC element, a Target Wake Time (TWT) element, a Traffic Specification (TSPEC) element, or some other format. Regardless, these subfields may be concatenated or aggregated to form a single PTSI field (or a field with another name).

In one example implementation, the list of the PTSI fields may be sent as a list of defined-length fields (for example, all are xx octets long). The list may optionally be preceded by a count field and/or a total-length field. Alternatively, or in addition, each entry may include a preceding field (e.g., 1 octet) containing a “Last PTSI” flag, which may be set to true for the final PTSI in the list.

In another example implementation, the list of the PTSI fields may be sent as a list of fixed-length fields, with the fixed length indicated up front. That is, a list of fixed-length fields may be included, where the field size is specified in advance. The list may optionally include a preceding count field and/or a total-length field. Additionally, each entry may include an always-present preceding field (e.g., 1 octet) containing a “Last PTSI” flag, which may be set to true for the final PTSI in the list. That is, a count and/or total-length field and/or in a always-present preceding field (e.g. 1 octet) there may be a “Last PTSI” field that may be set to true for the last PTSI in the list.

In yet another example implementation, the list of the PTSI fields may be sent as a list of variable-length fields, with the length of each field signaled at the start of each field. That is, a list of variable-length fields may be included, where the length of each field may indicated at the beginning of that field. The list may optionally be preceded by a count field and/or a total-length field. Additionally, each entry may include an always-present preceding field (e.g., 1 octet) containing a “Last PTSI” flag, that may be set to true for the final PTSI in the list. That is, a preceding count and/or total-length field and/or in a always-present preceding field (e.g. 1 octet) there may be a “Last PTSI” field that may be set to true for the last PTSI in the list. In yet another example implementation, the list of the PTSI fields may be sent as a list of sub-elements (for example, each carrying a type+a length+a value).

In a first example implementation, the listing of the PTSI fields, including any total-length, count and/or length fields may be sent inside a single MAPC element or Co-TDMA sub-element as a field that is always present, inside a MAPC element or single Co-TDMA sub-element as a field that is present when indicated by a “presence bit”, or inside a single MAPC element or Co-TDMA sub-element as a field that contains zero or more sub-elements or sub-sub-elements. In a second example implementation, the listing of the PTSI fields may also be sent or in a separate MAPC element or Co-TDMA sub-element with one of one or more new MAPC operation type fields (e.g., “PTSI List [establishment/update/teardown] information”), in a separate “PTSI List” sub-element, or in one “PTSI” sub-element per PTSI. For the first example implementation, these PTSI fields, when sent in a MAPC element or Co-TDMA sub-element, may include MAPC operation type=agreement establishment when sent initially, or may have MAPC operation type=agreement update when sent subsequently.

The list may be: a complete list each time (so then the identifier and operator are not needed), or as a change from the what was previously reported, where each PTSI may carry its own identifier and operator, or where the PTSIs are sorted into an add section, a change section, and a delete section (so each PTSI may carry its own identifier but does not need an operator). Each section may have a header, prefixing or intermingled with the list described above.

These Co-TDMA/PTSI sub-elements may be transmitted either over the air in a MAPC related frame such as a MAPC negotiation request or a MPC response frame, or via a Distribution system (DS) or another wired or mesh-based transport between the APs, including in tunneled or un-tunneled.

Upon receipt of this message, the recipient AP may update its list of PTSIs for the peer APs. In one example, the PTSI signaling may include information for one or more flows with QC that may be set up at the AP initiating the MAPC negotiation with another AP. The PTSI signal may contain list of one or more SCS descriptor elements, where each such element may include a QC element and may correspond to an SCS stream (identified by the SCS ID) that is set up at the AP initiating the MAPC negotiation. The signaling of PTSIs may include QC sub-elements without including SCS descriptor containers.

The QC sub-element or a modified QC element may include minimum and maximum service interval fields (or a single service interval field), a delay bound field, a minimum data rate field (or a service period duration field) and may also include a SST field. The SST field may be provided with reference to TSF of the requesting AP or the recipient AP.

STAs may or may not provide the SST in the QC sub-element of the flow. If no SST is provided by a STA, then AP may determine a SST value based on its own triggering schedule for the STA using Triggered Uplink Access-Optional (TUA-O). The SST value determination by the AP may include considering a start time of TWT/R-TWT schedules that may have been setup with the STA.

The AP may also provide a range of SST values to the other APs (for example, using a minimum SST field and a maximum SST field) to provide a range for the start time for the stream at the requesting AP, since AP may not have or be able to determine an exact start time for the flow. The recipient AP then may take into account the range of start time to decide whether to poll the requesting AP. The requesting AP may also aggregate the QoS requirements for multiple flows into a single QC sub-element and may provide QC information for the aggregated QoS requirements.

Once having sent the traffic profile to the plurality of co-channel APs at stage 220, method 200 may proceed to stage 230 where first AP 120 may receive a neighbor traffic profile from each of one or more co-channel APs of the plurality of co-channel APs. The neighbor traffic profile may include the stream identifier and the traffic characteristics for the flow identifier for each of one or more neighbor flows.

After receiving the neighbor traffic profile from one or more co-channel APs of the plurality of co-channel APs at stage 230, method 200 may proceed to stage 240 where first AP 120 may create a polling list comprising the one or more co-channel APs and the neighbor traffic profile for each of the one or more co-channel APs. The polling list may further include information about the schedule of the indicated streams, such that, for a given time or time range, it can indicate which APs reported they expect traffic at the at time. The polling list may be enhanced to record past experience (e.g., statistics related to whether the AP did indeed have traffic when it reported that it would and how often the AP was polled at times when the AP had reported it would have traffic), and, using this enhancement, the polling list can be used to report, for a given time or time range, which APs are expected to have traffic to send and/or which APs reported they would have traffic and have been under-polled with respect to the MAPC agreement and/or other APs.

Once having created the polling list comprising the one or more co-channel APs and the neighbor traffic profile for each of the one or more co-channel APs at stage 240, method 200 may proceed to stage 250 where first AP 120 may determine, upon receiving a TXOP, whether to poll at least one co-channel AP from the polling list to share the TXOP with. For example, after receiving such a MAPC related frame with a sub-element including PTSI, the recipient AP may update its list of streams it maintains for the requesting AP and may consider that information when polling APs during its Co-TDMA operation. If for some reason the recipient AP is not able to take into account the PTSI from the requesting AP during Co-TDMA polling, then it may signal that back in the MAPC negotiation response using a status value. It may also indicate that it may consider a subset of the PTSI for Co-TDMA polling in the MAPC negotiation response.

In one embodiment, the responding AP may signal that it may consider the PTSIs from the requesting AP in a quid-pro-quo manner, only if the first AP also considers PTSIs that is provided by the responding AP for the Co-TDMA operation. The responding AP may signal its PTSIs in the MAPC related response frame (which may overload the request from the second AP for considering its PTSIs). The first AP may then send another response frame confirming the set of PTSIs (from the second AP) it may consider in its Co-TDMA operation.

When the recipient AP obtains a TXOP, it consults its polling list (that ism its list of PTSIs stored), and a history of recent TXOP holding APs, for top promising peer AP(s), where a promising AP scores well in some function of one or more of the following: a) has PTSI(s) with a recently arising need for a SP, b) has not had a recent TXOP, c) whose PTSIs are actively or entirely transmitted on this link, and d) has a history of using a Co-TDMA poll, e) has been under-polled recently. A top promising AP is among the highest scoring promising APs, perhaps with some minimum score required. If there is a non-null set of top promising AP(s), the TXOP-holding AP attempts to poll these top promising AP(s) as part of Co-TDMA so as to help them deliver their PTSI-related traffic with low latency and high reliability.

After determining, upon receiving a Transmit Opportunity (TXOP), whether to poll at least one co-channel AP from the polling list for sharing the TXOP with at stage 250, method 200 may terminate at END stage 260.

In example implementations, the Co-TDMA MAPC negotiation may include a requesting first AP to request a second AP to consider polling the first AP during Co-TDMA operation in its TXOP, and indicate that it will do the same in return. If the second AP indicates an accept for the request to the first AP, then the two APs may now have an agreement where each may consider polling the other AP during its Co-TDMA operation. This Co-TDMA agreement may also include an additional aspect of using PTSIs that may be exchanged between the two APs (as described above) to decide whether to poll the other AP during a Co-TDMA operation.

In another example implementation, an AP may also use Co-R-TWT schedules (for example, a TWT start time, a TWT duration, and TWT interval information) that it may have negotiated with another AP when deciding which APs to poll during Co-TDMA operation. In this implementation, the Co-RTWT schedules may be used both for a Start Time Protection Rule (STPR) and for Co-TDMA polling purpose.

As part of MAPC Co-TDMA agreement setup with another AP, first AP 120 may request another AP (for example, second AP 130) to consider one or more R-TWT schedules during Co-TDMA operation to decide whether to poll first AP 120. First AP 120 may refer to Co-RTWT schedules that have already been set up between the two APs or may provide one or more R-TWT schedules in the Co-TDMA agreement itself. The recipient AP (that is, second AP 130) may indicate in a response if it would consider Co-R-TWT schedules during Co-TDMA operation for polling first AP 120. In one example, this Co-TDMA agreement for considering Co-R-TWT schedules may be mutually agreed as quid-pro-quo, where first AP 120 does this for second AP 130 if second AP 130 also does the same for first AP 120.

FIG. 3 is a block diagram of a computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for including a traffic profile in a MAPC negotiation described with respect to FIG. 2. Computing device 300, for example, may provide an operating environment for controller 110, first AP 120, second AP 130, third AP 135, first station 140, second station 150, third station 160, fourth station 170 and the like. Controller 110, first AP 120, second AP 130, third AP 135, first station 140, second station 150, third station 160, fourth station 170, and the like may operate in other environments and are not limited to computing device 300.

Computing device 300 may be implemented using an AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining a traffic profile comprising a stream identifier and traffic characteristics for a flow associated with the stream identifier for each of one or more flows for associated stations;
sending the traffic profile to a plurality of co-channel Access Points (APs);
receiving a neighbor traffic profile from one or more co-channel APs of the plurality of co-channel APs, wherein the neighbor traffic profile comprises the stream identifier and the traffic characteristics for the flow identifier for each of one or more neighbor flows;
creating a polling list comprising the one or more co-channel APs and the neighbor traffic profile for each of the one or more co-channel APs; and
determining, upon receiving a Transmit Opportunity (TXOP), whether to poll at least one co-channel AP from the polling list for sharing the TXOP with.

2. The method of claim 1, wherein the traffic characteristics comprises one or more of: a measure of priority, a service start time, a service start time range, a service interval, a service interval range, a nominal service duration, and whether the flow is entirely, predominantly, or occasionally being delivered on a link.

3. The method of claim 1, further comprising:
signaling, in response to receiving the neighbor traffic profile from a first co-channel AP, the first co-channel AP that the neighbor profile will be considered during polling based on a quid-pro-quo basis.

4. The method of claim 3, further comprising:
receiving, from the first co-channel AP, a response to the signaling, the response indicating that the first co-channel AP agrees to the quid-pro-quo basis.

5. The method of claim 1, wherein determining whether to poll the at least one co-channel AP from the polling list for sharing the TXOP with comprises:
determining a polling score for each of the one or more co-channel APs in the polling list; and
determining to poll the at least one co-channel AP having among a highest polling score and the polling score of the at least one co-channel AP being greater than a predetermined value.

6. The method of claim 5, wherein the polling score for a co-channel AP is determined based on one or more of: has the traffic profile with a recently arising need for a TXOP, has not had a recent TXOP, whose flows are actively or entirely transmitted on this link, has a consistent history of soliciting a portion of a TXOP in response to a Co-TDMA poll, and has been under-polled recently.

7. The method of claim 1, wherein receiving the neighbor traffic profile comprises receiving the neighbor traffic profile in response to co-channel Multi-Access Point Coordination (MAPC) negotiation.

8. A system comprising:
a memory storage; and
a processing unit coupled to the memory storage, wherein the processing unit is operative to:
determine a traffic profile comprising a stream identifier and traffic characteristics for a flow associated with the stream identifier for each of one or more flows for associated stations;
send the traffic profile to a plurality of co-channel Access Points (APs);
receive a neighbor traffic profile from one or more co-channel APs of the plurality of co-channel APs, wherein the neighbor traffic profile comprises the stream identifier and the traffic characteristics for the flow identifier for each of one or more neighbor flows;
create a polling list comprising the one or more co-channel APs and the neighbor traffic profile for each of the one or more co-channel APs; and
determine, upon receiving a Transmit Opportunity (TXOP), whether to poll at least one co-channel AP from the polling list for sharing the TXOP with.

9. The system of claim 8, wherein the traffic characteristics comprises one or more of: a measure of priority, a service start time, a service start time range, a service interval, a service interval range, a nominal service duration, and whether the flow is entirely, predominantly, or occasionally being delivered on a link.

10. The system of claim 8, wherein the processing unit is further operative to signal, in response to receiving the neighbor traffic profile from a first co-channel AP, the first co-channel AP that the neighbor profile will be considered during polling based on a quid-pro-quo basis.

11. The system of claim 10, wherein the processing unit is further operative to:
receive, from the first co-channel AP, a response to the signaling, the response indicating that the first co-channel AP agrees to the quid-pro-quo basis.

12. The system of claim 8, wherein the processing unit being operative to determine whether to poll the at least one co-channel AP from the polling list for sharing the TXOP with comprises the processing unit being further operative to:
determine a polling score for each of the one or more co-channel APs in the polling list; and
determine to poll the at least one co-channel AP having among a highest polling score and the polling score of the at least one co-channel AP being greater than a predetermined value.

13. The system of claim 12, wherein the polling score for a co-channel AP is determined based on one or more of: has the traffic profile with a recently arising need for a TXOP, has not had a recent TXOP, whose flows are actively or entirely transmitted on this link, has a consistent history of soliciting a portion of a TXOP in response to a Co-TDMA poll, and has been under-polled recently.

14. The system of claim 8, wherein the processing unit being operative to receive the neighbor traffic profile comprises the processing unit being operative to receive the neighbor traffic profile in response to co-channel Multi-Access Point Coordination (MAPC) negotiation.

15. A non-transitory computer-readable medium that stores a set of instructions which when executed perform a method executed by the set of instructions comprising:
determining a traffic profile comprising a stream identifier and traffic characteristics for a flow associated with the stream identifier for each of one or more flows for associated stations;
sending the traffic profile to a plurality of co-channel Access Points (APs);
receiving a neighbor traffic profile from each of one or more co-channel APs of the plurality of co-channel APs, wherein the neighbor traffic profile comprises the stream identifier and the traffic characteristics for the flow identifier for each of one or more neighbor flows;
creating a polling list comprising the one or more co-channel APs and the neighbor traffic profile for each of the one or more co-channel APs; and
determining, upon receiving a Transmit Opportunity (TXOP), whether to poll at least one co-channel AP from the polling list for sharing the TXOP with.

16. The non-transitory computer-readable medium of claim 15, wherein the traffic characteristics comprises one or more of: a measure of priority, a service start time, a service start time range, a service interval, a service interval range, a nominal service duration, and whether the flow is entirely, predominantly, or occasionally being delivered on a link.

17. The non-transitory computer-readable medium of claim 15, the method executed by the set of instructions further comprising:
signaling, in response to receiving the neighbor traffic profile from a first co-channel AP, the first co-channel AP that the neighbor profile will be considered during polling based on a quid-pro-quo basis.

18. The non-transitory computer-readable medium of claim 17, the method executed by the set of instructions further comprising:
receiving, from the first co-channel AP, a response to the signaling, the response indicating that the first co-channel AP agrees to the quid-pro-quo basis.

19. The non-transitory computer-readable medium of claim 15, wherein determining whether to poll the at least one co-channel AP from the polling list for sharing the TXOP with comprises:
determining a polling score for each of the one or more co-channel APs in the polling list; and
determining to poll the at least one co-channel AP having among a highest polling score and the polling score of the at least one co-channel AP being greater than a predetermined value.

20. The non-transitory computer-readable medium of claim 19, wherein the polling score for a co-channel AP is determined based on one or more of: has the traffic profile with a recently arising need for a TXOP, has not had a recent TXOP, whose flows are actively or entirely transmitted on this link, has a consistent history of soliciting a portion of a TXOP in response to a Co-TDMA poll, and has been under-polled recently.
